(19) United States
(12) Patent Application Publication
(10) Pub. No.: US 2005/0234735 A1
(43) Pub. Date: Oct. 20, 2005

(54) Digital rights management using proximity testing

(76) Inventor: Jim C. Williams, Yorba Linda, CA (US)

Correspondence Address: O'MELVENY & MYERS LLP, 400 So. Hope Street, Los Angeles, CA, 90071-2899, US

(21) Appl. No.: 10/998,030

(22) Filed: Nov. 24, 2004

Related U.S. Application Data
(60) Provisional application No. 60/525,651, filed on Nov. 26, 2003.

(51) Int. Cl. G06F 17/60

(52) U.S. Cl. 705/1

(57) ABSTRACT

A method and system for preventing unauthorized use of copyrighted digital information includes transmitting verification data from a source to a receiving device. The verification data includes a secure source identifier. A reply message from the receiving device includes a secure confirmation of receipt for the verification data and a secure identifier of the receiving device. An elapsed time is determined between the time of transmission of verification data and the time of receipt of the reply message. Authorization to use or receive the digital content is based at least in part on the elapsed time.

### CROSS-REFERENCE TO RELATED APPLICATION

This application claims priority pursuant to 35 U.S.C. § 119(e) to U.S. Provisional Application No. 60/525,651, filed Nov. 26, 2003, which application is specifically incorporated herein, in its entirety, by reference.

### BACKGROUND OF THE INVENTION

1. Field of the Invention

The present invention relates to a method and system for controlling distribution of digital copyrighted material over a broadband network, based on a determination of relative proximity or geographic location of the source device and a receiving device requesting content.

2. Description of Related Art

Recent developments in broadband technology have enabled cost-effective distribution of high-value content over a broadband network, both locally and remotely. For example, the increasingly wide availability of “plug-and-play” technology allows a broad range of consumer electronic devices be easily connected into digital cable networks. The set-top boxes of the past might thus be converted into distribution nodes of a broadband network. However, these increases in efficiency of broadband communication, along with the growing utilization of networked systems in and between homes, offices, and other locations, have also increased the threat of remote redistribution of digital content from paying to non-paying clients via the broadband connection. Fear of illegal and rampant copying and re-distribution of digital content over networked systems may prevent TV and movie providers from utilizing this method of transmission for their content. In order to take advantage of broadband distribution, new content protection and copy management systems should ensure the content cannot be redistributed to another customer or another location using a broadband distribution network.

It may also be desirable to prevent digital content from being redistributed out of a defined geographic area. For example, a broadcast of a sporting event that is “blacked-out” in certain areas might be received by a receiver connected to a broadband network, and redistributed in the blackout area via the broadband network. Traditional business models regarding licensing and distributing content over a broadcast network are typically based on location or geographic area. TV is licensed on a conditional access model, according to Designated Market Areas (DMAs) that are based on Nielsen defined geographic regions. For example, a Los Angeles television station is not licensed to broadcast to a New York audience. Pay-per-view television also has rules defining limited rights to content based on geographic scope, such as a subscription limited to a house or to homes within a specific region.

Mere re-broadcasting or redistribution of a content signal over a broadband network may not require any copying of content. Thus, traditional copy-protection methods focused on preventing copying of the content may not effectively prevent redistribution or rebroadcast of such content.

Therefore it is desirable to provide a method and system for determining with reasonable confidence a relative proximity or geographic location of any networked device receiving copyrighted digital content over a network. It is further desirable to make use of information regarding a networked device's relative proximity or geographic location information concerning one or more networked devices in a system for digital rights management.

### SUMMARY OF THE INVENTION

The present invention provides a system and method for determining the geographic location or relative proximity of a device receiving copyrighted digital content over a network. The location or proximity information can then be used to determine whether the receiving device is within a specified geographic range or proximity to a source device that is authorized for access to that content.

In an embodiment of the invention, a system according to this invention uses a secure time function to determine a time at which a message containing a cryptographically unique identifier is sent to the requesting device. The message may be sent via any one of a variety of known secure methods of communication, for example, by encrypting a message. The requesting device receives the message, modifies it with its own cryptographically unique identifier and returns the message to the source device via a known secure method of communication. Once the source device receives the reply message, it confirms that it is sent in response to the message originally sent and that the message could only have been modified by the requesting device, based on the unique identifiers. Then, the source device measures the elapsed time between sending of the original message and receipt of the reply, and uses a secure, updatable table of network characteristics with the measured time to determine a probability that the receiving device is local or close distance, medium distance or a long distance from the source device. Based on this determination of relative distance and the allowed geographic range for the requested content, the source device will either permit or deny access to the requested content.

Additionally or alternatively, the receiving device may also use a secure time function to stamp the message at the time it is received from the source device. Upon receiving and authenticating the reply message, the source device may simply measure the time differential between the time sent by the source and the time received by the receiving device. This time difference may also be used with information concerning network characteristics to determine the relative proximity of the receiving device. In addition, or in the alternative, a message transit time for the reply message may also be used to determine a device proximity.

The method as described above may not provide precise measure of distance between the source and requesting device. Generally, latency in communication networks is only partially determined by the distance between nodes, and can also be influenced by network topography and composition, as well as by transient network conditions. It may be possible, for example, for a nearby device to have a relatively long latency, while a more distant device has a relatively short latency, depending on intervening topography.

To address this issue, information concerning intervening network topologies may be determined from messages exchanged between a transmitting and a receiving device. Characteristics of certain topographies, including typical transmission times, may be stored in a secure, updateable table. Such stored information may be used with a determination of the network topology used for transmission and a measured transmission time to determine to greater precision whether the receiving device is close or distant.

A proximity estimate may be expressed in a probabilistic manner. For example, “there is a 95% certainty that the device is distant” represents a simple estimate of probable distance. According to an embodiment of the invention, a user may define a desired level of certainty as a threshold required before action is taken by a source device. For example, a 95% confidence that a device is nearby may be required. In addition, a definition of “distant” can be set by the source device; e.g., 200 feet, 100 m, and so forth. A source device can then determine within a user-defined certainty whether two devices are “close” or “distant.” If a relative distance is determined to be close, then the source device may perform a transaction that is contingent on closeness, such as transmitting video content. In the alternative, video transmission or transactions may be enabled for distant devices.

In another embodiment, this system and method permit the user to determine one or more requesting devices' location relative to the source device and to each other within a geographic area. In this embodiment, the source and requesting devices use existing audiovisual input receivers (AV receivers) such as terrestrial receivers, cable receivers, DSL receivers, MMDS receivers or other receivers to determine their own location relative to the known location of the AV receivers. In the alternative, or in addition, each device can use a known locating technology, for example automatic number identification (ANI), to determine their initial geographic location. ANI comprises a back-office headend database of customers' addresses and associated telephone numbers. In an ANI system, receiving devices are configured to periodically call the headend office, which uses the database and the incoming telephone number to verify the device address, as known in the art.

Once the known geographic location has been determined, the relative distances between the source device and all of the requesting devices and between the requesting devices themselves can be determined using the previously described comparison between the latencies of a sent and returned message. Then, the user can combine this information to determine within a high probability where the source and requesting devices are located. For example, this system can be used to determine whether the devices are located within a certain TV market or whether two requesting devices are near or distant from each other.

A more complete understanding of the geographic location determining method will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a flow chart illustrating exemplary steps of a method for preventing unauthorized access to copyrighted digital information, based on elapsed time between message transmissions.

FIG. 2 is a flow chart illustrating exemplary steps of an alternative method for preventing unauthorized access to copyrighted information, based on statistical probabilities of relative distance between the source and requesting devices.

FIG. 3 is a flow chart illustrating exemplary steps of an alternative method for preventing unauthorized access to copyrighted information combining statistical data on relative distance between devices with initial location information from audiovisual receivers.

FIG. 4 is a block diagram showing an exemplary system according to the invention.

FIG. 5 is a block diagram showing an exemplary system using audiovisual receivers to determine the initial geographic locations of the source and requesting devices.

### DETAILED DESCRIPTION OF THE PREFERRED EMBODIMENT

The present invention provides a method and system for determining the geographic location of a network device, or relative proximity of an interconnected devices, and use of such information for digital rights management over a network, that overcomes the limitations of prior art. In the detailed description that follows, like element numerals are used to describe like elements appearing in one or more of the figures.

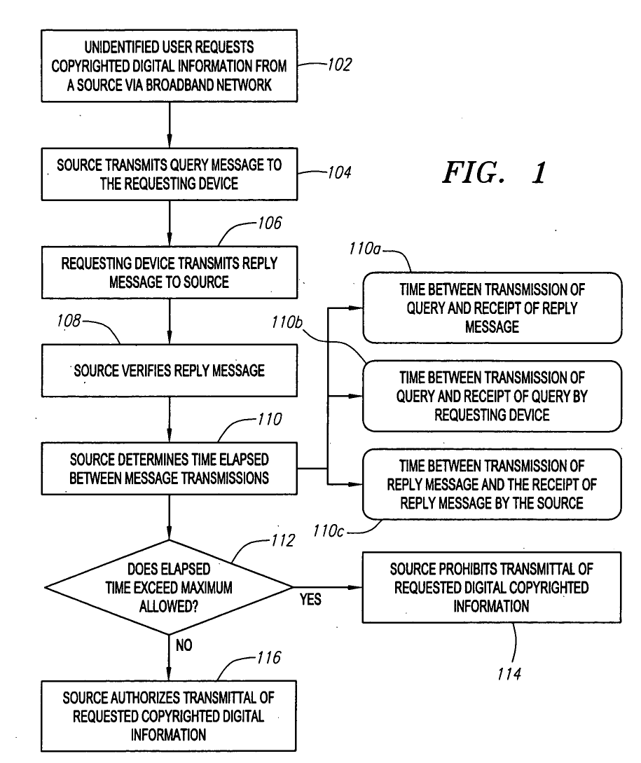

FIG. 1 shows a method 100 for determining whether a user is authorized access to content based on relative proximity to the source. At step 102, the potential user requests specific digital content from the source device via a remote network connection. For example, the request may be received via the Internet, a local area network, a cable network, a satellite data link, or other network connection as known in the art.

At step 104, the source device sends a query message to the requesting device. This query message is used to gather information on the transmission time of a message between the source and requesting device, which will later be used to determine the relative proximity of the requesting device. This message at a minimum contains a cryptographically secure unique identifier of the source device. It may also contain a timestamp noting the time the message was sent and a demand for additional data, such as a timestamp for both receipt of the query message and transmission of the reply message, from the requesting device.

At step 106, the requesting device receives and responds to the query from the source device. The requesting device sends a reply message to the source device. The reply message comprises a confirmation of the original message and a cryptographically secure unique identifier of the requesting device. In addition, depending upon the source query demands, the reply message may also include a timestamp noting when the message was received, a timestamp noting when the reply message was transmitted, or other information responsive to the source query.

At step 108, the reply message is verified. For example, the source device may confirm that the message contains a valid confirmation of the original query message and that the unique identifier of the requesting device is valid. In turn, the requestor identifier may be validated, for example, by comparing the identifier to a database of known subscribers to the particular content, or to known licensees of a particular content protection technology.

Once the message is verified, the time elapsed between message transmissions is measured. At step 110, the source device measures the time elapsed between any one or ones of the following transmissions: (step 110a) between transmission of the query message and receipt by the requesting device; (step 110b) between transmission of the reply message and receipt by the source device; or (step 110c) between transmission of the query message and receipt of the reply message by the source. For example, the source may determine only one of the elapsed times, or may determine all of the possible times, with or without computing an average. The elapsed times will be measured solely according to the internal clock of the source device. In the alternative, or in addition, a timestamp added by the receiving device to the reply message may be used. In this case, the elapsed times can be measured by comparing the difference between time stamps for transmission and receipt of either or both messages. However, the source device will have to first make sure it synchronizes its clock with the requesting device.

At step 112, the elapsed time may be compared to a table of maximum allowable times for message transmission or other suitable benchmark, to determine whether the user is authorized to receive the requested content. The table of maximum times may comprise an updatable database generated by the content provider and uploaded to the source device. According to an embodiment of the invention, therefore, the time of transmission is used as a proxy for relative distance between the source and requesting devices and based on a comparison to the geographic conditional access rules for each piece of content sets a maximum time for message transmission. If the time between message transmissions exceeds this maximum, the source will deny access to the content at step 114. If the time between the measured transmissions is under the maximum, the source will authorize transmission and access to the content for the specific requesting device at step 116.

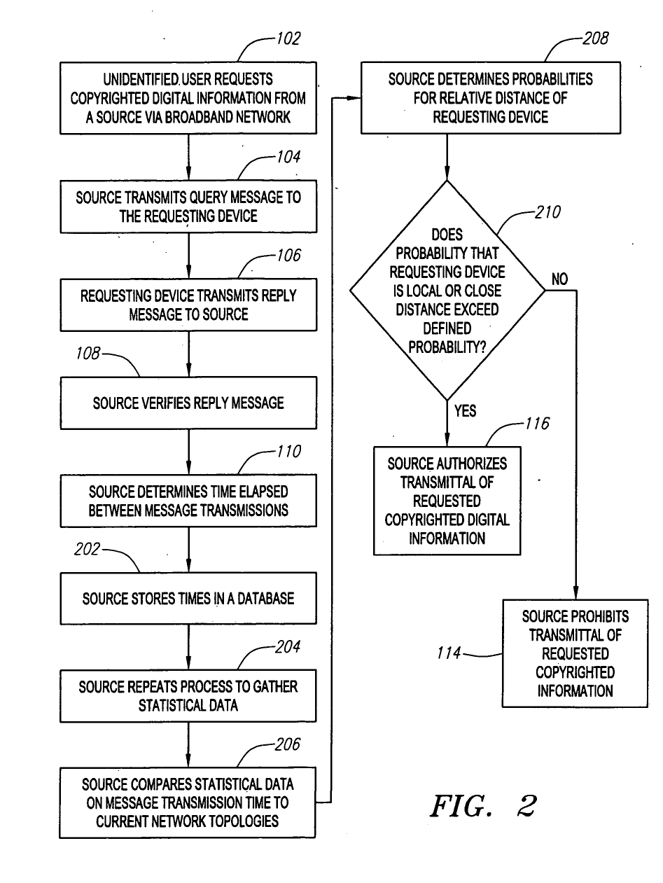

Various different methods may be used within the scope of the invention to accomplish content management with geographic location determination. FIG. 2 shows an alternative method of determining the relative geographic distance based on multiple queries from the source device. Like method 100, method 200 is initiated when the source device receives a message requesting content from an unidentified user, or from a known user in an unidentified location, in step 102. This method is similar to method 100 in that the source transmits a query message in step 104, to which the requesting device receives and replies at step 106. However, method 200 diverges from method 100 once the source device verifies the reply message in step 108 and determines the elapsed time between transmissions in step 110. Instead of making a authorization determination from this single data point, the source stores this information in a database at step 202 and repeats the message query and reply process of steps 104-110 multiple times to gather multiple data points regarding the time to transmit a message between the source and receiving devices in step 204. Each time, the data regarding transmission time and signature of the network topology used to transmit the message is stored in a database within the source device in step 202. Once the source has acquired enough data points, determined by a user input rule, the source compares this information to a chart of time ranges based on the different topological assumptions in step 206 and determines the probability that the requesting device is close distance from the source in step 208. If the probability exceeds a user defined minimum for the given piece of content, the source permits access to the requested material at step 116. If the probability does not meet the user defined minimum for the content, the source denies access to the requested content at step 114.

The gathering of transmission latency data, calculation of distance, and the decision to transmit or withhold content from a receiving device need not take place as an unbroken sequence of steps. For example, it may not be necessary to calculate a location for a receiving device prior to every transmission of content. Instead, it may be more efficient or faster to characterize relative remoteness or a device location at periodic intervals. Once a device location has been characterized, its status may be maintained without further collection of distance or location data. To maintain current and accurate location information, however, location or distance should be recalculated at periodic intervals, as appropriate.

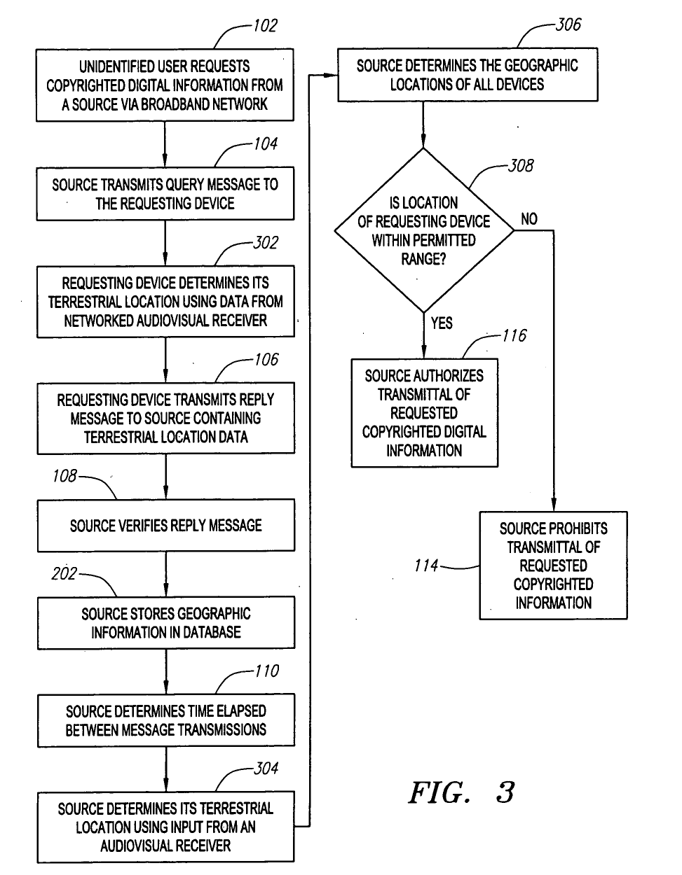

FIG. 3 is a flow diagram showing an alternate method 300 for determining whether a user is authorized access to content based on a combination of the known location of one or more devices and the latencies in message transmission between one or more devices. In method 300, steps 102, 104, 106, 108 and 110 are performed in the same manner as in method 100. However, in this embodiment, the requesting device performs an additional step 302 of determining its geographic location before transmitting a reply message to the source's query message at step 106.

In one embodiment, the receiving device uses automatic number identification (ANI) technology to determine its geographic location at step 302. This information is then attached to the reply message along with the other information requested in the query message, which may include but is not limited to the requesting device's unique identification, a timestamp noting when the query message was received and a timestamp noting when the reply message is sent.

In another embodiment, the receiving device determines its position based on input from an audiovisual receiver (AV receiver) at step 304. Examples of an AV receiver include terrestrial receivers, cable receivers, satellite receivers, DSL receivers, MMDS receivers and other types. Each receiver of this type receives a broadcast or transmission from a source that transmits from a known point location and has a defined broadcast or transmission footprint. The size or range of the footprint varies depending on the type of receiver. For example, a terrestrial transmitter is licensed to broadcast from a certain latitude and longitude at a particular power level. Thus, the range of the broadcast will be determined by propagation characteristics, geography and weather of the area. For cable transmission, the range is determined by the physical cables and the signal levels of the cable distribution plant. For satellite broadcast, the range is larger, however, there is still a defined geographic area able to receive the signal. If a device can receive a signal from a given receiver, then its geographic location can be established within the range or footprint of that receiver's signal.

In this embodiment, the AV receiver may be connected to the requesting device or to any one of multiple devices in close proximity (e.g., a home) that are locally networked together. The requesting device gathers this position information either from its own AV receiver connection, or from one of the other home networked devices to which it knows it is in close proximity, at step 302. This information is then attached to the reply message along with the other information requested in the query message, which may include but is not limited to the requesting device's unique identification, a timestamp noting when the query message was received and a timestamp noting when the reply message is sent.

At step 106, this reply message is sent to the source device where the message is verified 108 and the information regarding the geographic location is stored in the database 202 while the source determines the time elapsed between message transmissions according to step 110. At step 304, the source device determines its geographic location using ANI technology or input from an AV receiver and stores this data. At step 306, the source device may use a combination of data regarding the known locations of the devices and the message latency between devices to determine the relative locations of all the devices. Even though the source device and the requesting device may not be able to verify their proximity to each other, they both may be able to confirm where they are and communicate that information to each other. The source device may have direct knowledge of its geographic location or it may be in close proximity to another device that knows its geographic location. Likewise, the requesting device may have direct knowledge of its geographic location or it may be in close proximity to another device that knows its geographic location.

For example, if the source device determines that it is in Los Angeles based on its broadcast receiver, and if a requesting device is requesting access to content that is only allowed to be accessed by devices in Los Angeles, then the source device may determine that the requesting device is in Los Angeles as a condition of access to the content. The source device may, for example, determine the location of the requesting device by (i) confirming that the requesting device is in close proximity to the source device (already known to be in Los Angeles); (ii) confirming that the requesting device has determined itself to be in Los Angeles; or (iii) confirming that the requesting device is in close proximity to a third device that has determined itself to be in Los Angeles, such as by using another broadcast receiver or ANI.

It should be apparent that proximity information may be used in conjunction with other information to determine whether or not to authorize a particular transmission. That is, proximity of the source device to the requesting device is not necessarily the only determining factor in all embodiments of the present invention. Other factors may be given lesser, equal, or even greater weight in making an access determination. It should also be apparent that the permitted range or geographic area for a receiving device may be either close or remote from source. For example, a remote receiving device may receive content authorized for transmission to its geographic area, or content on which no geographic restrictions have been placed.

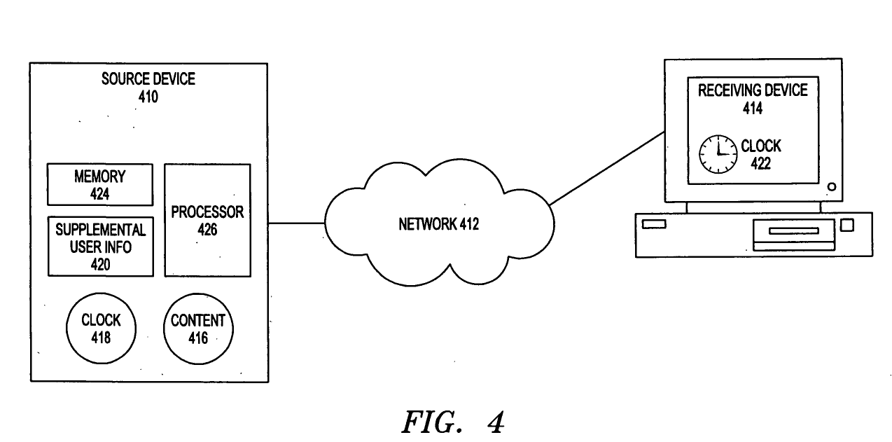

FIG. 4 is a block diagram showing an embodiment of a system 400 suitable for use with the invention. System 400 may comprise a source device 410 connected to at least one of various possible receiving devices 414 at a number of receiving sites by network 412. Suitable receiving devices may include, for example, set-top boxes, DTV receivers, or computer systems with DRM player. In one embodiment, network 412 is a cable network. In addition, or in the alternative, system 400 may include other networks for transmitting digital information to receiving devices; for example, the Internet, a digital satellite television link, or other wired or wireless networks.

Receiving device 414 requests specific digital content 416 from the source device over the network 412. Once the source device receives the request it generates a query message embedded with its unique identifier. The query message request specific information from the receiving device including but not limited to the receiving device's unique identifier, the time at which the message was received, the time at which the reply message was sent, and the geographic location of the receiving device.

The receiving device 414 generates a reply message embedded with its unique identifier and containing the information requested by the query message, including but not limited to the time at which it received the message, its geographic location if known, and the time at which it sends the reply. The receiving device then sends the reply message back to the source device 410 over the network 412.

When the source device 410 receives the reply message, it confirms that the message contains the unique query message and that only the specified receiving device 414 could have modified it. The source device 410 also notes the absolute time the reply message was received using its secure clock 418 and the network topology used to transmit the messages. In one embodiment, the source device simply determines the time elapsed between transmission of the query message and receipt of the reply message, and compares that time with a maximum allowable time for that particular piece of content based on the network topology used to transmit the messages.

The table of maximum times may comprise a portion of the supplemental user supplied information 420 created by the source device. It contains maximum times for different content based on the content provider's business rules. If the time is under the maximum allowable time, the source device 410 then approves the request and permits the receiving device 414 to access the requested content 416 by either transmitting it to the receiving device over the network 412 or otherwise providing access to a current broadcast stream. If the time exceeds the maximum allowable time, the source device 410 denies access to the content 416.

In an alternate embodiment where the receiving device also has a secure clock 422 synchronized to clock 418 of the source device, the receiving device can add the time of receipt of the query message and the time of reply transmission to the reply message using a cryptographically secure method. In this case, the source device 410 will be able to determine the time elapsed between transmission and receipt of the query message and time elapsed between transmission and receipt of the reply message, as well as time elapsed between the overall process. The source device then has three data points to compare to the table of maximum times 420, which in this embodiment would also include maximum times for transmission of the query and reply messages as well as for the overall process. This will provide slightly more accuracy for the approval decision.

In yet another embodiment, after the source device 410 receives the reply message from the receiving device 414 and measures the elapsed times, it stores that information in its memory 424 and repeats the process of sending a query message, receiving a reply from the receiving device and calculating the elapsed time. The source device 410 repeats this process a defined number of times to gather data on the latency of message transmission. The processor 426 then calculates the average latency for message transmission based on this data, compares it to an updatable table of network latencies contained in the supplemental user supplied information 420 and determines a probability that the receiving device is close or local distance, medium distance or far distance. These probabilities are compared to a table of allowable probabilities for each piece of content which is also contained within the user supplier supplemental information 420. If the probability that the receiving device is close or local is within the range for the requested content, the source device 410 approves the request and permits access to the content 416 by the receiving device 414. If the probability is not within the permitted ranges for the requested content, then the source device 410 denies access to the content 416 by the receiving device 414.

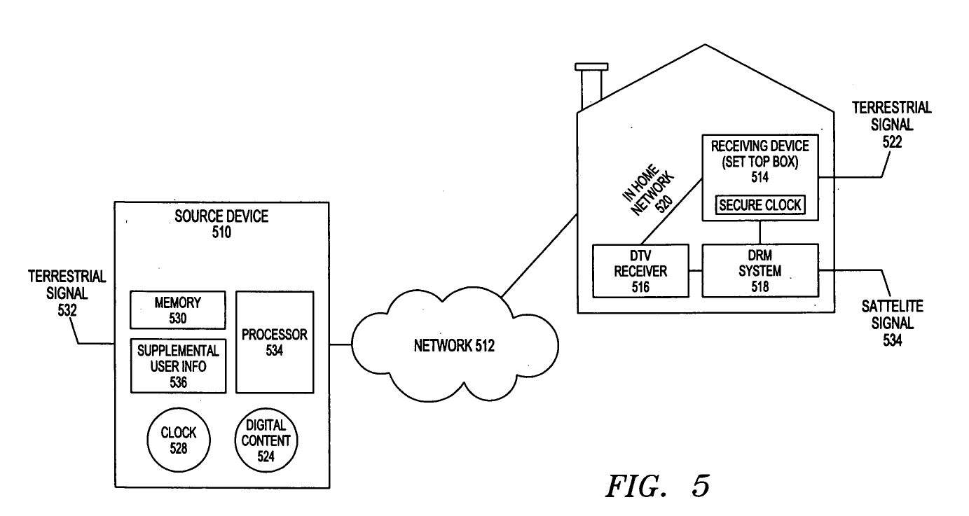

FIG. 5 is a block diagram showing an exemplary system 500 configured to determine relative proximity and geographic locations of one or more source or receiving devices. The system generally comprises a source device 510 connected to various receiving devices at a number of receiving sites, including set-top boxes 514, DTV receivers 516 or computer systems with DRM player 518, by network 512. In one embodiment, network 512 comprises a cable network. In the alternative, or in addition, system 500 may comprise other networks for transmitting digital information over a local area network, for example, the Internet, a digital satellite television link, and other wired or wireless networks. Within the receiving sites, all the devices are locally networked via an in-home network 520. At least one source or receiving device in at each receiving site is also connected via an AV input receiver to a signal, such as a terrestrial signal 522, or to a cable signal or a satellite signal 534.

During operation of system 500, the receiving device 514 may request specific digital content 524 from the source device 510 over network 512. The source device 510 will generate a query message embedded with its unique identifier and send it to the receiving device 514 over the network 512. The query message requests specific information from the receiving device, including but not limited to the receiving device's unique identifier, the time at which the message was received, the time at which the reply message was sent and the geographic location of the receiving device. If requested, the receiving device 514 notes the time the query message was received using its secure absolute clock 526. Then, the receiving device 514 determines its geographic location using the attached AV signal input 522. In the alternative, the receiving device may use input from a signal 534 that is attached to another device (e.g., computer 518) where the other device is attached to receiving device 514 over an in-home network 520. The receiving device 514 then records the time it is sending the reply message, if requested, using its secure clock 526 and sends the reply message back to the source device 510 over the network 512.

When the source device 510 receives the reply message, it records the time on its secure absolute clock 528, confirms that the message contains the unique query message and that only the specified receiving device could have modified it. Once the message is confirmed, the source device extracts and stores the information in the reply message on the time of receipt of query and sending reply and the geographic location. The source device 510 determines at least one of the times elapsed between transmission of the query message and receipt of the reply message, transmission and receipt of the query message and transmission and receipt of the reply message, and stores this information in its memory 530. Source device 510 may repeat the process of sending a query message, receiving a reply, and calculating and storing the elapsed time information any desired number of times to gather data on the latency of message transmission. The source device also determines its known geographic location using signal input from a connected AV receiver 532.

The processor 534 then calculates the average latency for message transmission based on this data, compares it to an updatable table of network latencies contained in the supplemental user supplied information 536 and determines a probability that the receiving device is close or local distance, medium distance or far distance. Next, the processor 534 compares the probabilities regarding relative distance of the devices with their known geographic location information stored in the memory 530. Based on a combination of this information, the source device can determine the geographic location of all the devices. This location data is evaluated against business rules for each piece of content that is contained within the user supplied supplemental information 536. If the location of the receiving device is within the permitted range for the requested content, then the source device 510 approves the request and permits access to the content 524. If the location of the receiving device is not within the permitted range, then the source device 510 denied access to the requested content 524.

Having thus described a method and system for controlling access to digital content based on geographic location, it should be apparent to those skilled in the art that certain advantages of the within system have been achieved. It should also be appreciated that various modifications, adaptations, and alternative embodiments thereof may be made within the scope and spirit of the present invention. For example, a system wherein the requesting device is a set top box has been illustrated, but it should be apparent that the inventive concepts described above would be equally applicable to other types of television devices, music devices, computing devices, personal assistants, mobile telephones, cellular telephones, and other similar devices. In addition, the system can be used to control the flow of any type of communication where absolute or relative geography and proximity are determinative. The invention is defined by the following claims.

1. A method for preventing unauthorized use of copyrighted digital information comprising the steps of:
receiving a request for copyrighted digital information from a receiving device;
transmitting verification data from a source to the receiving device wherein the verification data comprises a secure source identifier;
receiving a reply message from the receiving device wherein the reply message comprises a secure confirmation of receipt for the verification data and a secure identifier of the receiving device;
determining an elapsed time between at least one of (a) the time of transmission of verification data and the time of receipt of the reply message, (b) the time of transmission of the verification data and a time of receipt of the verification data by the receiving device, or (c) a time of transmission of the reply message from the receiving device and a time of receipt of the reply message by the source; and
determining whether to transmit the copyrighted digital information to the receiving device, based at least in part on the elapsed time.

2. The method of claim 1, further comprising authorizing the transmission of copyrighted digital material if the elapsed time does not exceed a defined maximum time.

3. The method of claim 1, wherein the transmitting step further comprises transmitting the verification data comprising a first secure timestamp recording the time of transmission of the message to the receiving device.

4. The method of claim 3, wherein the receiving step further comprises receiving the reply message comprising a second secure timestamp recording a time of transmission of the reply message to the source device.

5. The method of claim 4, further comprising synchronizing timestamp clocks of the source and receiving device.

6. The method of claim 1, further comprising comparing the elapsed time to a table of network latencies to determine a probability that the receiving device is within a defined distance of the source; and
wherein the second determining step further comprises making the second determination based at least in part on whether a probability that the receiving device is further than the defined distance away exceeds a defined maximum probability.

7. The method of claim 6, wherein the second determining step further comprises authorizing delivery of the copyrighted material if the probability that the receiving device is closer than the defined distance away exceeds a defined probability.

8. The method of claim 1, further comprising gathering statistical data on latency of message transmission by repeating the steps of transmitting verification data, receiving a reply message and determining an elapsed time.

9. The method of claim 8, further comprising comparing the statistical data on the latency of message transmission to a table of network latencies to determine a probability that the receiving device is further than a defined distance from the source; and
wherein the second determining step further comprises making the second determination based at least in part on whether a probability that the receiving device is further than the defined distance away exceeds a defined maximum probability.

10. The method of claim 9, wherein the second determining step further comprises authorizing delivery of the copyrighted material if the probability that the receiving device is closer than the defined distance away exceeds a defined probability.

11. The method of claim 1, further comprising determining a geographic region within which the receiving device is likely located.

12. The method of claim 11, wherein the second determining step further comprises using a defined maximum time that is short enough to prevent transmission of the copyrighted material, if the source and receiving device are not both in the geographic region.

13. The method of claim 11, wherein the determining location step further comprises using automatic number identification (ANI) technology to locate the receiving device within a geographic region defined by a telephone area code.

14. The method of claim 11, wherein the determining location step further comprises using input from an audiovisual receiver to locate the receiving device within a region defined by a broadcast signal range.

15. The method of claim 11, further comprising determining a geographic region within which the source device is likely located.

16. A system for preventing unauthorized use of copy-protected content, comprising:
a processor operable to execute program instructions;
a memory operably associated with the processor, the memory holding the program instructions comprising:
receiving a request for copyrighted digital information from a receiving device;
transmitting verification data from a source to the receiving device wherein the verification data comprises a secure source identifier;
receiving a reply message from the receiving device wherein the reply message comprises a secure confirmation of receipt for the verification data and a secure identifier of the receiving device;
determining an elapsed time between at least one of (a) the time of transmission of verification data and the time of receipt of the reply message, (b) the time of transmission of the verification data and a time of receipt of the verification data by the receiving device, or (c) a time of transmission of the reply message from the receiving device and a time of receipt of the reply message by the source; and
determining whether to transmit the copyrighted digital information to the receiving device, based at least in part on the elapsed time.

17. The system of claim 16, wherein the program instructions further comprise authorizing the transmission of copyrighted digital material if the elapsed time is within a user-defined time.

18. The system of claim 16, wherein the program instructions further comprise transmitting the verification data comprising a first secure timestamp recording the time of transmission of the message to the receiving device.

19. The system of claim 18, wherein the program instructions further comprise receiving the reply message comprising a second secure timestamp recording the time of transmission of the reply message to source device.

20. The system of claim 19, wherein the program instructions further comprise synchronizing timestamp clocks of the source and receiving device.

21. The system of claim 16, wherein the program instructions further comprise comparing the elapsed time to a table of network latencies to determine a probability that the receiving device is within a defined distance away from the source; and
wherein the second determining step further comprises making the second determination based at least in part on whether a probability that the receiving device is further than the defined distance away exceeds a defined maximum probability.

22. The system of claim 21, wherein the program instructions further comprise authorizing delivery of the copyrighted material if the probability that the receiving device is closer than the defined distance away exceeds a defined probability.

23. The system of claim 16, wherein the program instructions further comprise gathering statistical data on latency of message transmission by repeating the steps of transmitting verification data, receiving a reply message and determining an elapsed time.

24. The system of claim 23, wherein the program instructions further comprise comparing the statistical data on the latency of message transmission to a table of network latencies to determine a probability that the receiving device is within a defined distance from the source; and
wherein the second determining step further comprises making the second determination based at least in part on whether a probability that the receiving device is further than the defined distance away exceeds a defined maximum probability.

25. The system of claim 24, wherein the program instructions further comprise authorizing delivery of the copyrighted material if the probability that the receiving device is closer than the defined distance away exceeds a defined probability.

26. The system of claim 16, wherein the program instructions further comprise determining a geographic region within which the receiving device is likely located.

27. The system of claim 26, wherein the program instructions further comprise using a defined maximum time that is short enough to prevent transmission of the copyrighted material, if the source and receiving device are not both in the geographic region.

28. The system of claim 26, wherein the program instructions further comprise using automatic number identification (ANI) technology to locate the receiving device to within the geographic region defined by a telephone area code.

29. The system of claim 26, wherein the program instructions further comprise using input from an audiovisual receiver to locate the receiving device to within the geographic region defined by a broadcast signal range.

30. The system of claim 26, wherein the program instructions further comprise determining a geographic region within which the source device is likely located.
